(19) United States
(12) Patent Application Publication
(10) Pub. No.: US 2007/0160801 A1
(43) Pub. Date: Jul. 12, 2007

(54) Panel constructions and assemblies made therefrom

(75) Inventor: Peter Johnstone, Victoria (AU)

Correspondence Address: FITZPATRICK CELLA HARPER & SCINTO, 30 ROCKEFELLER PLAZA, NEW YORK, NY, 10112, US

(73) Assignee: First Green Park Pty Ltd., Humevale (AU)

(21) Appl. No.: 10/587,383

(22) PCT Filed: Dec. 23, 2004
(86) PCT No.: PCT/AU04/01841

§ 371 Date: Dec. 20, 2006

(30) Foreign Application Priority Data
Jan. 23, 2004 (AU) 2004900343
Jun. 25, 2004 (AU) 2004903499
Oct. 29, 2004 (AU) 2004906260

(51) Int. Cl. B32B 5/00

(52) U.S. Cl. 428/98

(57) ABSTRACT

The specification discloses a panel or object construction including an inner support frame and an outer skin that encloses the support frame, the outer skin being formed by a plurality of layers of at least one flexible plastics material film web wound about the support frame at least partially overlapping a previously positioned said flexible plastics film web, whereby at least some overlapping regions of a said web or webs are adhered to each other, the panel or object construction being utilized to form containers, to form graphics display panels, to form evaporation restriction panels and to form desalination apparatus. The specification also discloses apparatus for forming panel constructions in accordance with the invention.

The present invention relates to a novel panel and containers or similar products assembled therefrom.

### BACKGROUND OF THE INVENTION

It is known to form panels, containers or objects from a variety of materials and constructions. Commonly used materials include wood including plywood, cardboard including corrugated cardboard, expanded polystyrene, polyurethane, glass, and rigid and semi-rigid plastics including corrugated plastic board and the like. Each of these materials has certain advantages for particular applications but most also have disadvantages making their use at best a compromise in many applications. For example, wood is a relatively expensive material that is difficult to fabricate into panels, containers or crates. Panels, containers and crates made from wood are also generally quite heavy. Cardboard is relatively inexpensive both as a material and in fabricating same into a container or the like, however, it is not waterproof. Polystyrene formed into a container, box or crate is expensive to freight because of its volume. Wood including plywood and rigid or semi-rigid plastics provide limited or no protection against damage to products packed inside such containers and provides limited thermal insulation qualities.

### SUMMARY OF THE INVENTION

The present invention aims at providing an inexpensive novel panel or object construction and assemblies utilising such an object or panel construction including containers and the like, that will overcome many of the aforementioned difficulties with known materials and constructions.

Accordingly, the present invention provides a panel or object construction including an inner support frame means and an outer skin at least partially enclosing said support frame means formed at least in part by at least one layer of at least one flexible web wound about said support frame means at least partially overlapping a previously positioned said flexible web whereby at least some overlapping regions of a said web or webs are adhered to each other. Preferably, a plurality of said layers are formed whereby at least some of said layers are adhered to at least one other said layer. Preferably, the outer skin retains flexibility after being applied to the support frame means and also provides some tension to or pressure on the support frame means. Preferably the outer skin may fully enclose the support frame means. Preferably, at least one said flexible web may be a plastics film. Conveniently, the or each flexible web utilized might be an oriented plastics film, stretched plastics film or a plastics film pre-stretched beyond its yield point but retaining some memory whereby it will constrict on the support frame means after application. A linear low density polyethylene film material pre-stretched in this manner is suitable (but not essential) for the performance of this invention. Conveniently, the outer skin may be made completely of one or more flexible plastics film webs, or it may be made of plastics film web and at least one other web, for example of a reinforcing mesh or other material. Such other material may include rigid or semi-rigid panels such as plywood, panels, such panels might be positioned within the wound plastics material film or on either side of same to provide increased strength if required. The object or panel construction accordingly may provide, depending on the embodiments utilised, a relatively lightweight panel construction that is inexpensive to produce and which may be water or liquid proof and may also provide protection for the goods that might be packed in a container utilising such panel constructions. In one preferred embodiment the inner support frame means may define an internal free space region within the outer perimeter dimensions of same with the outer skin substantially enclosing said internal free space region. The outer skin may be water or liquid proof such that water or liquid cannot enter the internal free space region, or in the alternative, and preferably if inlet/outlet means is/are provided, the internal free space region may be adapted to contain water in some other liquid. It will of course be recognized that the same feature might provide the inlet and the outlet to the internal free zone region. The inlet/outlet means are preferably re-sealable by any suitable means. Conveniently the inner support frame means may be formed in or parallel to a flat plane, or alternatively may be three dimensionally formed. Conveniently the support frame means includes convex curved surfaces facing outwardly of the internal free zone region.

In a further possible arrangement, the internal free space region might be filled or partially filled with a polyurethane, polystyrene (or similar) plastics foam material rigid or semi-rigid panel prior to the outer skin being formed. Alternatively the internal free space region might be filled with an injected plastics material foam (such as polyurethane, polystyrene or the like) after the outer skin has been formed.

Preferred features of the object or panel construction may be as defined in claims 2 to 23 annexed hereto, the subject matter of these claims being hereby incorporated into the disclosure of this specification by the reference thereto.

As used in this specification, the terms “support frame means”, “frame element” and the like are intended to convey a meaning of both a continuous support element such as, for example, a sheet of corrugated cardboard or similar, or an open frame with an outer perimeter support defining a largely open space in between, either being generally planar in form or three dimensional in form.

In accordance with a further aspect, the present invention provides a graphics display panel including a rigid inner support frame means and an outer skin enclosing said support frame means formed at least in part by at least one layer of at least one flexible plastics film web wound about said support frame means at least partially overlapping a previously positioned said flexible plastics film web whereby at least some overlapping regions of a said flexible plastics film web or webs are adhered to each other, and graphics indicia being carried on an outer surface of said outer skin. Preferred features of this aspect may be as defined in claims 25 and 26 annexed hereto, the subject matter of these claims being incorporated into the disclosure of this specification by this reference thereto.

According to a still further aspect, the present invention provides an evaporation restrictor panel including a rigid inner support frame means and an outer skin enclosing said support frame means formed at least in part by at least one layer of at least one flexible plastics film web wound about said support frame means at least partially overlapping a previously positioned said flexible plastics film web whereby at least some overlapping regions of a said flexible plastics film web or webs are adhered to each other.

According to yet another aspect of the present invention there is provided a desalination apparatus including a rigid inner support frame means and an outer skin enclosing said support frame means formed at least in part by at least one layer of at least one flexible plastics film web wound about said support frame means at least partially overlapping a previously positioned said flexible plastics film web whereby at least some overlapping regions of a said flexible plastics film web or webs are adhered to each other, said support frame means and said outer skin defining a sealed internal zone having inlet and outlet arrangement means to introduce and remove water to be desalinated to and from said internal zone, said outer skin having at least one upper region upwardly inclined from at least one hollow zone of said support frame means, said support frame means further including water collection and drainage means to collect pure water condensed on said upwardly inclined region and deliver same to said at least one hollow zone of the support frame means.

The present invention also anticipates utilizing panel constructions as described above in an assembled form to provide a container or a wall construction for various applications as defined in claims 29 to 33 annexed hereto. The subject matter of these claims is also incorporated into the disclosure of this specification by this reference thereto.

The present invention also proposes to utilize a wall construction element including at least one rectangular shaped panel construction as described above and further including retainer means engaging and retaining opposed edges of the panel construction. Preferred features of such a wall construction element may be as defined in claims 31 to 37 as annexed hereto, the subject matter of these claims being hereby incorporated into the disclosure of this specification by this reference thereto.

According to a still further aspect of this invention there is provided a panel construction including an inner support frame means and a flexible outer skin at least partially enclosing said support frame means formed at least in part by at least one flexible web wound about said support frame means in at least partially overlapping manner whereby at least some overlapping regions of said web or webs are adhered to other, said support frame means having two mutually parallel first frame members spaced from one another with each said first frame member having at least one hinge zone such that the hinge zones in the spaced first frame members are arranged in at least one pair with the or each said pair defining a hinging axis about which portions of the first frame members on either side of said hinge zones can be positioned into differing relative dispositions, after having said flexible outer skin applied to said inner support frame means. Preferred features of this further aspect may be as defined in claims 39 to 53 annexed hereto, the subject matter of these claims being hereby incorporated into the disclosure of this specification by this reference thereto.

The present invention also provides a flat panel assembly including a plurality of (Claim 54) Preferred features of this aspect may be as defined in claims 55 to 59 annexed hereto, the subject matter of these claims being hereby made part of the disclosure of this specification by this reference thereto. A container as defined in claim 60 annexed hereto may be formed from such a flat panel assembly.

The present invention also provides apparatus for wrapping a support frame means with an outer skin formed at least in part by a plurality of layers of a flexible web wound about said support frame means, said apparatus including a first conveying means and a second conveying means, the first and the second conveying means being arranged to move the support frame means to and fro between the first and second conveying means, and a roll of said flexible web disposed between the first and the second conveying means being movable between a relatively elevated position and a relatively lowered position, the flexible web being successively positioned along a first face of the support frame means with the roll of said flexible web in the elevated position as the support frame means moves between the first and the second conveying means, whereupon, the roll of said flexible web moves to the lowered position and the flexible web is positioned along a second face of the support frame means opposite to said first face as the support frame means moves again between the first and the second conveying means.

Preferred features and aspects of the aforementioned apparatus may be as defined in claims 62 to 65 as annexed hereto, the subject matter of these claims being, by this reference thereto, incorporated into the disclosure of this specification.

In accordance with another aspect, the present invention also provides apparatus for wrapping a support frame means with an outer skin formed at least in part by a plurality of layers of a flexible web wound about said support frame means, said apparatus including a first conveying means and a second conveying means being arranged to move the support frame means between the first and the second conveying means, and at least one roll of flexible web disposed generally between said first and said second conveying means and disposed to orbit about said support frame means as it moves between the first and the second conveying means to lay helical windings of said flexible web onto said support means, said apparatus further including first flexible web application means to apply at least one flexible web length either below or over the helical windings in a longitudinal direction of said support frame means on opposed faces of said support frame means. The flexible web being deposited on the support frame means may be a plastics material film and film having different characteristics might be applied to the support frame means depending on the needs of the product ultimately being manufactured. For example black or other opaque film might be applied to one side of the support frame means with clear or translucent film being applied to the other side. If the helical wound film is also clear or translucent then the end product will be an enclosed support frame with clear or translucent film layers on one side and black or opaque layers on the other side.

Conveniently the apparatus further includes second flexible web application means to apply one or more flexible webs on the other side of the flexible web helical windings in a longitudinal direction. Again these further flexible webs may be plastics film webs and may have their characteristics chosen depending on the requirements of the end product. Apart from colour or light transmissivity of the film, other control features can also be incorporated such as providing adjustable brake mechanisms to vary the tension of the film being applied and dimpling or other pressure rollers to achieve air pockets or other features in the applied film layers.

### BRIEF DESCRIPTION OF THE DRAWINGS

Many other applications for the panel construction of this invention will become apparent from the following description of preferred embodiments given in relation to the accompanying drawings, in which:

FIG. 1 is a schematic front view of a panel construction according to a preferred embodiment of the present invention;

FIG. 1a is a section view along line A-A of FIG. 1;

FIG. 2 is a schematic perspective view of a container utilising a plurality of panel constructions as shown in FIG. 1;

FIG. 2a is a partial section view along line A-A of FIG. 2;

FIG. 2b is a partial section view along line B-B of FIG. 2;

FIG. 2c is a partial section view along line C-C of FIG. 2;

FIGS. 3a to 3f are section views of possible elements for forming the perimeter rigid frame formation of panel constructions according to preferred embodiments of the present invention;

FIG. 4 is an edge elevation view of a possible further preferred embodiment of the present invention;

FIG. 5 is a partial plan view of a frame construction used in the preferred embodiment of FIG. 4;

FIG. 5a is a partial plan view similar to FIG. 5 showing a further preferred embodiment adapted to enable production of a partially or fully enclosed container.

FIGS. 5b and 5c are illustrative examples of alternative embodiments for making a hingeable frame assembly;

FIG. 6 is a plan view, in flat construction format, of an assembly of panel members capable of being formed into a liquid retaining container;

FIG. 7 is a perspective view of the assembly shown in FIG. 6 erected into the liquid retaining container;

FIG. 8 is a plan view of the preferred embodiment shown in FIG. 4 formed into a tubular configuration;

FIG. 9 is a detail view of the corner marked A of the configuration shown in FIG. 8;

FIG. 10 is a detail view of each of the corners marked B of the configuration shown in FIG. 8;

FIG. 11 is a schematic perspective view of a possible wall configuration for utilising panel constructions according to the present invention, particularly for forming a container on a pallet base;

FIG. 11a is a partial section view along line A-A of FIG. 11;

FIG. 11b is a partial section view along line B-B of FIG. 11;

FIG. 12 is a schematic perspective view of a raft intended to limit evaporation from water storage areas constructed in accordance with a preferred embodiment of a panel construction according to the present invention;

FIG. 13 is a partial and schematic section view of a panel construction similar to FIG. 12 adapted for use in desalination of water containing salts;

FIG. 14 is a schematic plan view of one possible apparatus for producing panel constructions according to a preferred embodiment of the present invention;

FIG. 15 is a schematic side elevation view of the apparatus illustrated schematically in FIG. 14 and

FIG. 16 is a schematic side elevation view of a further preferred embodiment for producing panel constructions according to preferred embodiments of the present invention.

### DETAILED DESCRIPTION OF THE PREFERRED EMBODIMENTS

FIGS. 1 and 1a of the annexed drawings illustrate, by way of example only, one possible preferred embodiment of the present invention. In this embodiment a panel construction 10 is provided with a rigid perimeter frame 11 and an outer skin 12 totally enclosing the frame 11. The outer skin 12 is made up of layers of flexible plastics material film wound onto the frame 11 with the layers being at least partially adhered to one another. Conveniently, at least one such layer of film web might be wound onto the frame 11 in a first cross direction with at least one further layer of the film web being wound onto the frame 11 in a second cross direction transverse to said first cross direction. If desired, two or more layers of the film web may be wound in the first cross direction prior to winding at least one or conveniently two or more layers in the second cross direction. Preferably, the angle between said first and second cross directions is between 60° and 120°, and most preferably at about 90°. It is preferred that the flexible plastics material web be slightly greater in width than the width of the frame 11, however, if the frame 11 is larger in size than the available film web width, then the film web may be spirally wound onto the frame 11 with the web being applied overlapping a previously applied web length. Alternatively, the film may be applied in a plurality of partially overlapping spaced sections. The number of layers of film web applied to the frame 11 to form the outer skin 12 may be varied to achieve a desired strength and other performance characteristics for the intended use of the panel construction. The plastics material film may be a pre-stretched plastics film that is stretched beyond its yield point to increase its length and decrease its thickness while retaining some memory in the film whereby it will construct on the frame 11 once applied. Plastics film such as linear low density polyethylene may be used in this way but other plastics film can also be used. Different films with differing retained tension levels may be used to utilize differing characteristics in the end product. Alternatively differing films can be applied with differing tensions to achieve similar results. The film web forming the outer skin 12 may be self adhesive plastics film which may have had an adhesive additive included in the film material formulation, or the film might be co-extruded film including at least two layers in which one outer layer is formed by an adhesive resin. In a still further possible arrangement, an adhesive might be applied to or coated on a surface of the film prior to or during its application to the frame 11 to form the outer skin 12. In another possible arrangement, a laminating adhesive layer might be applied between non-adhesive layers of flexible web material. Any applied adhesive or adhesive incorporated in or on the film may be a fire resistant adhesive.

If the frame 11 is totally enclosed by the outer skin 12, air is initially trapped in the cavity or space 13 within the frame 11. Further air may then be trapped with each subsequent wrap of film web either in the cavity 13 or between the layers of the film web. This may be achieved by utilizing dimpled rollers or the like as the film is wound onto the frame 11 or a partially wrapped such frame 11. By repeating this process, the desired insulating properties and/or cushioning properties can be achieved for the panel construction 10. If the film web is applied with pressure to the frame 11, the pressure applied to the frame by the film tends to increase the seal between layers of the film web to trap the air in the cavity 13 and/or between the layers as described above.

It has also been found that by applying the film web loosely or dimpling the film web prior to or as it is applied will cause more air to be trapped between the layers of the outer skin 12, if this is desired. A further possible option is to provide a dimpling or similar effect on inner or intermediate layers of the film web with smooth or flat film web layers applied as outer layers to improve the outward appearance of a panel construction formed in this manner.

The pressure of the air remaining in the cavity 13 may, if desired, be controlled by perforating one or both sides of the outer skin 12 or the layers of the outer skin 12 to ensure that the air within the cavity 13 remains at atmospheric pressure regardless of its temperature when used.

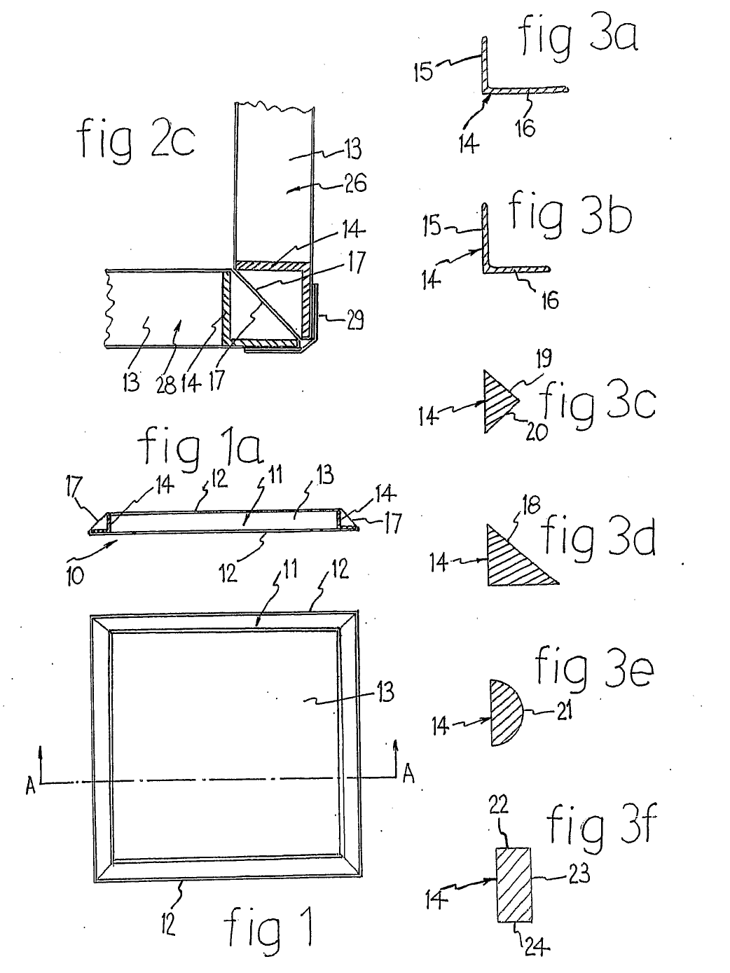

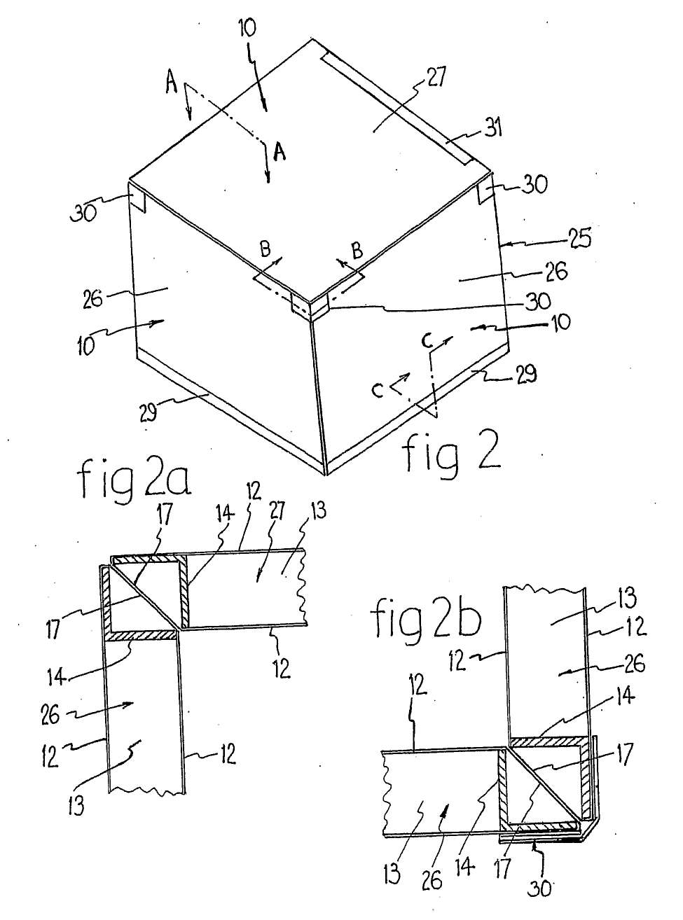

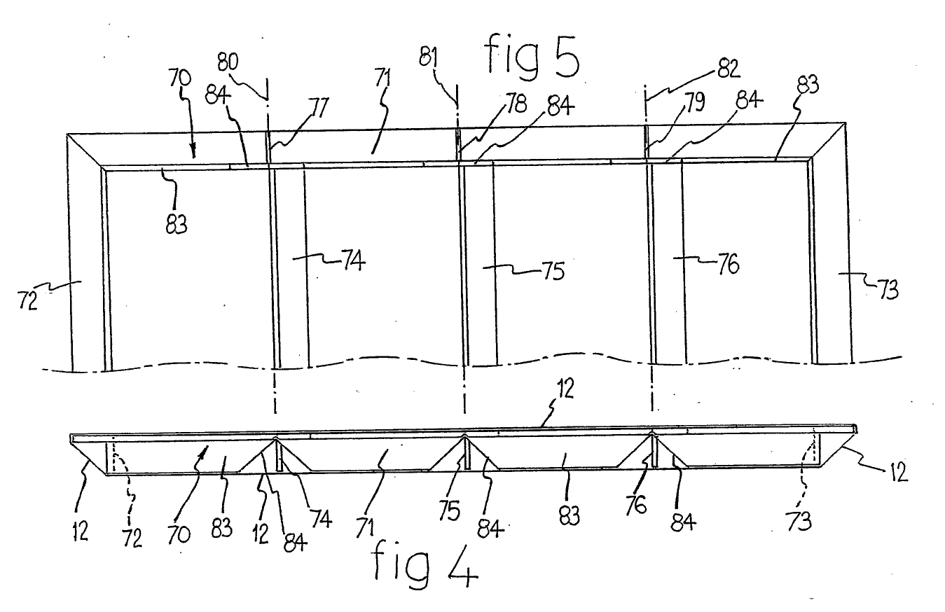

In FIGS. 1 and 1a, the frame 11 is fabricated from a metal such as steel or aluminium (or alloys thereof), timber including pine, or perhaps from a rigid or semi-rigid plastics material of any desired cross-section but in preferred applications having an L-cross-section 14 as shown in FIGS. 3a and 3b or triangular cross-sections as shown in FIGS. 3c and 3d. With one L-shaped structure, the legs 15, 16 of the L-section members 14 might be the same or could be different, however, if a container such as is shown in FIG. 2 is to be produced, then it is preferable that the legs 15, 16 be of equal length. In use the outer skin 12 forms a bevelled surface 17 between the outer edges of the legs 15, 16. Alternatively, a triangular section such as shown in FIG. 3d might be used which presents a surface 18 over which the outer skin 12 might be formed equivalent to the bevelled surface 17. FIG. 3c shows another triangular section for the members 14 which presents a pair of bevelled surfaces 19, 20 over which the outer skin 12 might be formed. FIG. 3e shows a possible semi-circular cross-section having an outer curved surface 21 over which the outer skin might be formed. It is believed this section improves the sealing of the film web layers to one another if this characteristic is desired. FIG. 3f illustrates another possible rectangular (or square) cross-section presenting an outer square or flat surfaces 22, 23 and 24 over which the outer skin 12 might be formed. A similar effect with a lower weight level might be achieved utilising a channel or C-section with the legs of the C-section facing inwardly or outwardly. In addition a circular profiled section could also be used and of course any of the profile sections could be used as a hollow or tubular section such as metal tubing or plastics piping or tubing. While FIGS. 1 and 1a show one preferred embodiment utilising a square (or rectangular) rigid perimeter frame 11, it will be appreciated that, depending upon the application, other shapes might be employed including triangular shapes and other polygonal shapes. The frame 11, as shown in FIGS. 1 and 1a, is illustrated as being fabricated from individual members 14, however, it may in some applications be moulded or cast in one piece. The frame 11 needs to be sufficiently rigid to support the outer skin 12 of flexible plastics material web applied to it but the material used to form the frame 11 could vary depending upon the application and depending upon whether the frame 11 is to be recycled or reused as discussed below. Suitable materials, depending upon the application, might include metals and metal alloys, timber, formed cardboard, rigid plastics material, a flexible inflatable plastics material or combinations of the aforesaid materials. Moreover, internal stiffening or reinforcing members to achieve the required stiffness of the frame 11 might be used.

FIGS. 2, 2a, 2b and 2c schematically illustrate a container or box 25 having a base wall 28 (see FIG. 2c), from upstanding side walls 26 (two of which are shown) and a lid or closure wall 27. Each of the base, side and upper closure walls may be formed by a panel construction 10 as illustrated in FIGS. 1 and 1a. It will be appreciated that by varying the shape and the dimensions of the panel constructions 10, containers of differing sizes and shapes might be produced. Many variations are possible including but not limited to providing a container without an upper closure or lid, and providing polygonal (other than square or rectangular) containers by providing a polygonal shaped base wall (and, if required, lid) with rectangular (or square) side walls connected to each side of the polygonal shaped base wall. With the preferred embodiment illustrated in FIG. 2, the panel constructions 10 each have bevelled edge faces 17 disposed at 45° to the plane of the panel construction such that adjacent panel constructions form a 90° corner with the bevelled edge faces 17 contacting one another (see FIG. 2a). The side walls 26 may be hingedly connected to the base wall 28 by the use of adhesive tape 29 applied substantially fully along the adjacent edges of the panel constructions.

In the upright or assembled condition of the container or box 25, the side walls 26 are maintained adjacent one another by releasable fastening means 30 such as a Velcro (registered trade mark) fastening tab or the like. Other retaining arrangements might also be used including circumferential strapping bands, adhesive tape or over wrapping with further plastics material film web. Still further mechanical latches could also be employed if suitable for the end product. The lid or upper closure wall 27 might be simply loosely applied or it may be connected to a side wall 26 by hinging tape 31. When the container is packed, each of the adjacent edges of the panel construction might be secured by sealing tape. If desired, one or more releasable fastening means (such as tabs 30) might be applied to releasably secure the lid or upper closure wall 27 in the closed state. In one configuration strapping bands adhesively taped to the container walls could be used. In any embodiment, when opening the container, one wall might be partially or fully removed to allow access to or removal of the contents from the container.

In an alternative arrangement, the panel constructions 10 forming the container might be temporarily held in the finished or erect state and thereafter have a further layer or layers of plastics material film web wound around the container to secure same in the erect state. Alternatively, adhesive tape material or strapping material could also be used to hold the container in the erect state. This may include the side walls and base wall only or might also include the upper lid or closure wall. If desired, advertising, promotional or other printed material might be provided on a sheet placed on an outer wall surface of a panel construction with the sheet being retained in place by an outer layer or layers of clear or transparent plastics material film web wound around the panel construction. Alternatively, if the container is to be formed as described above with an outer wrapping of plastics material film web, then the printed material sheet might be located between this outer wrapping (if it is clear or transparent) and the previously formed panel constructions.

As will be apparent, containers of the above described type might be readily shipped to an end user in a flat condition to be erected, packed and secured in a suitable manner. Containers may be shipped either as individual panel constructions or as such panel constructions hingedly connected to one another. It is believed that the rigid perimeter frames 11 might be formed and arranged in adjacent formation to be wrapped with plastics material film web or webs simultaneously such that the plastics material film web will form hinging and connection means between panels intended to form a container or the like.

In the case of containers for storing produce, it may be desirable to provide some air flow openings into and out of a container manufactured as aforesaid. This might be achieved by providing members forming the frame 11 for at least one panel (eg for a container floor) that are capable of bowing upwardly, at least partially under tension applied by the flexible outer plastics film skin whereby at least a partial air gap occurs at one or more corners. Alternatively, the film layer or layers, once applied might be perforated to allow air flow.

In a possible further preferred embodiment, rigid perimeter frames 11 as aforesaid may be initially connected by hinge means such as a flexible hinge sheet or part glued or otherwise fastened to adjacent edges of the rigid perimeter frames 11 allowing the adjacent edges of the frames 11 to pivot about a hinge axis between and parallel to the adjacent edges. The thus interconnected frames 11 may then be wrapped with plastics material film web or webs such that the film web will then also span the zones between adjacent edges of the panels of a container or the like formed therefrom.

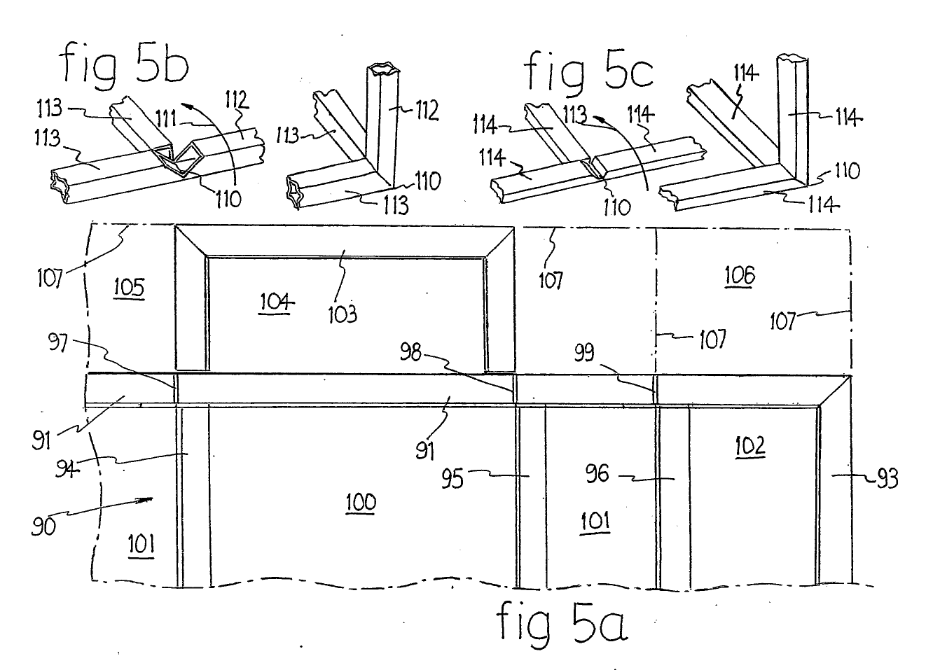

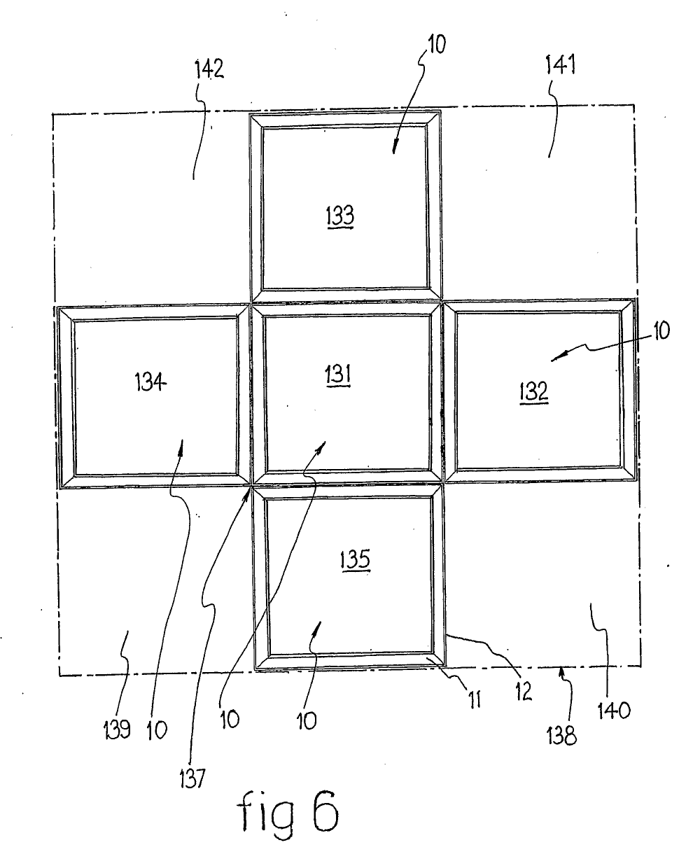

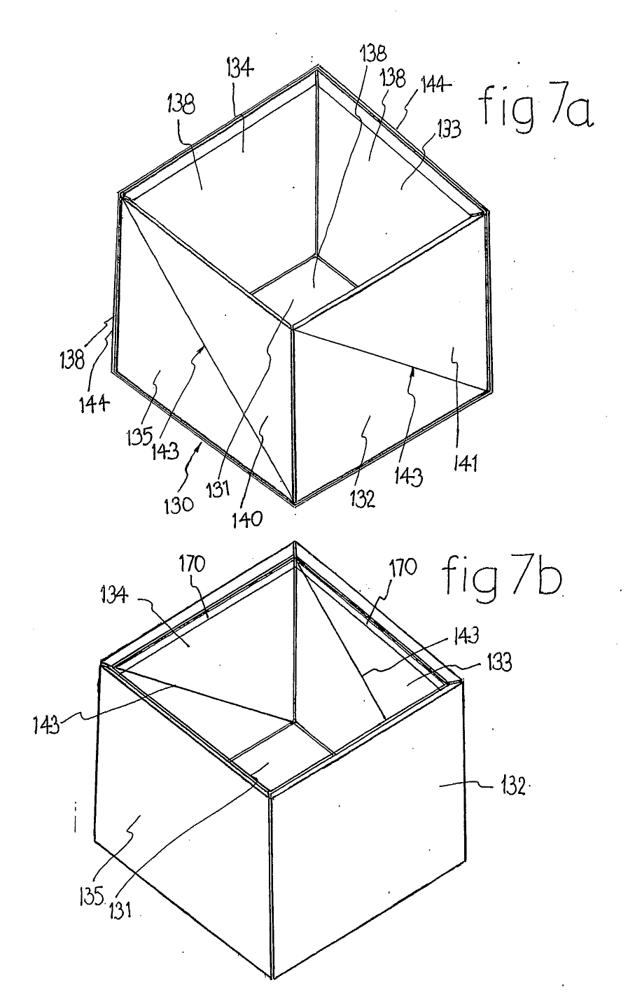

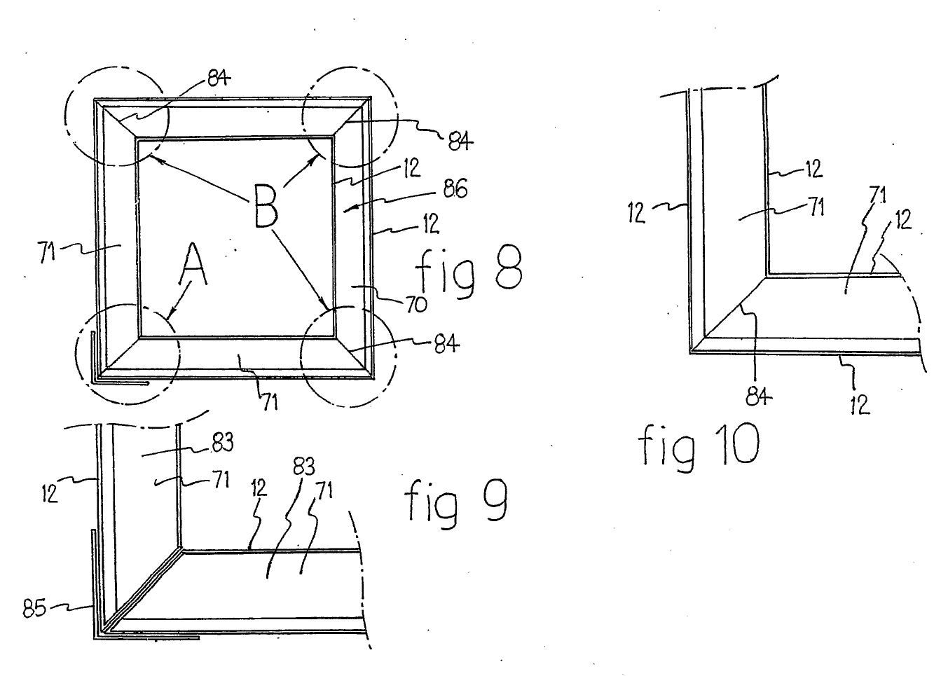

FIGS. 4 to 5c and 8 to 10 of the annexed drawings illustrate, again by way of example only, a further possible preferred embodiment of the present invention. In FIGS. 4 and 5, a rectangular frame assembly 70 is formed by a pair of side bars 71 (only one of which is shown) and a pair of end bars 72, 73. Three spaced intermediate cross bars 74, 75 and 76 are provided welded, glued or otherwise fastened at each end to the side bars 71. In the embodiment illustrated the bars 71 to 76 have an angle bar or L-shape cross-section and may typically be formed from metal, plastics material, cardboard or any other materials identified in the preceding test. It will also be recognized that although an L-shaped configuration has certain practical advantages, other cross-sections for the bars 71 to 76 could be used, as described elsewhere in this specification, depending upon the end product or use being made of the assembly. As is further shown in FIGS. 4 and 5, hinge zones 77, 78 and 79 may be formed in the side bars 71 to define hinge axes 80, 81 and 82. Each hinge zone 77, 78 or 79 might be formed cutting the web 83 of the side bars 71 to form bevelled notches 84 angled towards the hinge axes such that the side bars 71 can be bent around the hinge axes to form a square tubular shape 86 as illustrated in FIG. 6. It will readily be appreciated that the number of hinge axes 80 to 82 and the angle of the bevelled notches 84 may be selected so as to allow the assembly to be bent into any tubular shape including rectangular, triangular, hexagonal or any polygonal shape. Two or more such frame structures might be combined to produce a desired end product. In the bent and formed configuration shown in FIG. 8, the cross bars 74, 75, and 76 together with the two end bars 72, 73 form the upright corners of the tubular structure formed by this process.

Before the frame assembly 70 is bent about the hinge axes 80 to 82, the assembly 70 is wrapped by one or more flexible plastics material film webs, as with the previously described embodiments, to provide a skin 12 on both sides and around the edges of the frame assembly. Preferably a film web having a width equal to the distance between the side bars 71 might be wrapped longitudinally around the frame assembly 70 passing in one or more layers about the end bars 72, 73. If the distance between the two side bars is too great for the available film width then two or more film webs mutually spaced but overlapping might be utilized in the first wrapping step. Subsequently one or more flexible plastics material webs might be helically wrapped about the frame assembly 70 passing circumferentially about the side bars 71 and extending along the frame assembly in overlapping relation between the two end bars 72, 73. Thereafter a second layer of longitudinally wound film web or webs might be provided over and around the end bars 72, 73 and extending in a similar direction to the first mentioned layer. Alternatively two layers of helically wound flexible film web material may be provided separated by one layer of longitudinally wound material. Further layers of flexible plastics material may be built up on previously formed layers until the desired performance level for any particular application has been achieved. The nature of the flexible plastics material film and any related performance characteristics may be as described with earlier embodiments. Once the flexible plastics material film web skin 12 has been formed, the frame assembly is bent to the tubular structure 86 shown in FIG. 8 and the adjacent engaging edges formed by the end bars 72, 73 might be secured together by any suitable means such as adhesive tape 85 or by further over wrapping the tubular structure thus formed with additional layers of plastics material film web.

It will of course also be recognized that if required, the tubular structure formed as described above might be formed into a container by providing a lid and/or a base constructed as described above with reference to preceding embodiments. One possible use for containers of this type might be for packaging white goods or many other products in an inexpensive and convenient manner.

FIG. 5a illustrates yet another possible preferred embodiment similar to FIG. 5 but having differing features as described hereinafter. In this case the frame assembly 90 is also formed from angle or L shaped material, typically metal, cardboard or plastics material with hinging zones 97, 98 and 99 formed in a longitudinal bar member 91. A second such bar member is located in the opposite side (not shown) and the two bar members are connected by transverse bar members 94, 95, 96 and an end bar member 93. A second end bar member and further transverse bar member is not illustrated. The arrangement is such that the respective bar members are connected to define a base panel 100, two side panels 101 and two lid forming panels 102 (only one of which is illustrated). A pair of further frame members 103 adapted to form side panel members 104 (again only one of which is shown) are positioned adjacent to the base panel 100 and extend laterally therefrom. The frame members 103 might be positioned loosely next to longitudinal bar members 91 and hinged thereto by the covering outer skin subsequently applied thereto. In some cases specific hinge means might be used to connect the frame members 103 to the bar members 91. In some cases, the frame members 103 might need to be spaced from the bar members 91 and in this case “rigid” hinge means might be required, ie rigid in the sense that it would resist forces applied by the subsequent film wrapping process in the plane of the frame assembly 90 but have one or more hinge zones to permit hinging of the frame members 103 relative to the bar members 91 when erecting a container or the like. It will of course be appreciated that in some cases a hinged lid might not be required and lid forming half panels 102 might therefore be omitted. The broken outline 104, 107 in FIG. 5a indicates the envelope of the outer skin 12 after wrapping plastics film web onto the frame 90. The portions 105, 106 would need, after erection of the container, to be folded against the outer surface of the container by adhesive tape or further over wrapping of the container with plastics film web. It will also be readily apparent that a container constructed in this manner is also liquid proof such that the container might be used to hold, store or transport liquids or semi-liquid materials.

FIG. 5b illustrates a possible corner structure utilizing hinging zones 110 in rigid tube material 113 where one leg 112 is bent in the direction of arrow 111 to form a three dimensional structure from an originally formed flat frame that might be wrapped with plastics film web as described herein. FIG. 5c illustrates a similar arrangement but where the frame forming material is solid flat rectangular strip material 114.

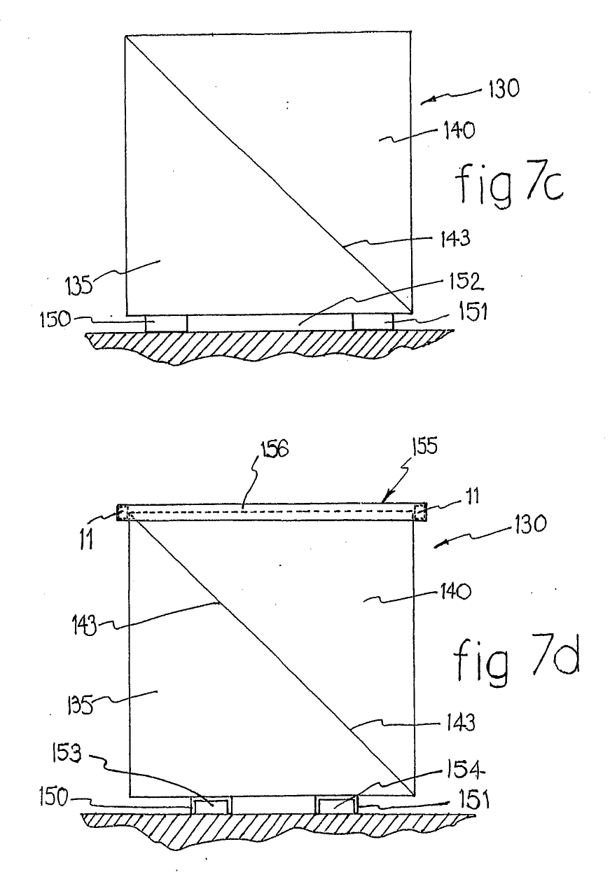

Referring to FIGS. 6 and 7a to 7d, another method of making a container is shown that may be made liquid proof, ie capable of containing liquids and other flowable materials. As shown in FIG. 6, a plurality of panels 10 constructed, for example, as shown in FIGS. 1 and 1a are provided and configured with one central panel 10 adapted to form a container base 131 of the container 130 and a number of similar panels 10 each adapted to form a sidewall panel 132, 133, 134 and 135 of the container 130 such that one edge of each side wall panel 132 to 135 is arranged closely adjacent an edge of the base wall panel 131. In the illustrated embodiment, each of the panels 131 to 135 are generally square but it will be appreciated that rectangular panels could also be used. The base 131 could also be triangular or some other polygonal shape if desired. Each of the panels 131 to 135 may be wrapped in plastic film material envelope 12 as is the case in any of the embodiments described herein. Furthermore, as described earlier, insulation material such as plastics material foam including polystyrene may be included in the internal space of the panels, either before or after wrapping with the plastic film material envelope 12. Conveniently the internal frame member 11 of each panel is constructed to provide a bevelled film surface at each edge that cooperates with a similar bevelled film surface on an adjacent panel member when configured into a container shape. The arrangement 137 of panels 131 to 135 might be simply positioned as illustrated in FIG. 6 with edges closely adjacent one another or they may be partially retained in this configuration by applying a hinging tape or the like to the film surfaces of adjacent panels 10. Whichever method is used, the arrangement 137 of panels 131 to 135 are then over wrapped with plastic film, preferably having a width equal to or in excess of the width of three panels 10 as illustrated. Alternatively the over wrapping might be by two or more film webs that overlap one another. The film web or webs are preferably wound about the panel arrangement 137 in a first direction parallel to sides of the panels 10 laying two or more layers of film via such winding. Then the film web or webs might then be wound in a second direction generally 90° to said first direction to lay two or more layers of film in this second direction. The process may thereafter be continued (or not) until sufficient layers of film have been wound over the panel arrangement 137 to form a liquid tight envelope 138. The envelope 138 in the specific embodiment illustrated in FIG. 6 is generally square with square flaps 139, 140, 141 and 142 in its corners made only of plastics film material. Thus, when the side panels 132 to 135 are rotated upwardly relative to the base panel 131 to form a container 130 as shown in FIG. 7a, the corner film portions 139, 140, 141 and 142 form triangular flaps 143 that may be folded against the side panels 132 to 135. The container formation 130 as shown in FIG. 7a may be retained in the erected formation by any suitable means but one preferred method is to over wrap the side walls and triangular flaps with a further layer or layers of plastic film 144. Other means may include adhesive tape, circumferential strapping and mechanical latching devices. It will of course be apparent that a top panel 10 might be provided to close the container thus formed or closure (if required) might be achieved by over wrapping the top with plastics material film in one or two perpendicular directions. The envelope 138 ensures that the edges of container 130 cannot leak liquids or other flowable materials that might be kept within the container 130.

In another embodiment, panels 10 may be positioned as shown in FIG. 6 which are then covered on one side (the side intended to form the inside of a container) only with a single (or multiple) layers of a material that is adherable to the panels 10 directly or by adhesive means provided for the purpose. The one or more layers having a perimeter 138 as shown in FIG. 6. Thereafter the panels 10 are erected to form a container as described above. In this case triangular flaps are formed on the inside with the top edges preferably being sealed by adhesive tape 170 as shown in FIG. 7b. The single or multiple layers may be a plastics film layer but could be made of or include other materials including metal foils provided the material is flexible or bendable.

FIGS. 7c and 7d schematically show front elevation views of the container 130 shown in FIG. 7 but further illustrate other preferred features. FIG. 7c shows spaced bearers 150 and 151 secured at either end to the edge frame structure 11 within the outer envelope. The bearers 150, 151 are spaced apart to provide a zone 152 to enable lifting forks of a lift truck or the like to access under the container so enabling handling of same when desired. As indicated in FIG. 7d, the bearers 150, 141 may be inverted channel shaped members each providing an internal zone 153, 154 for locating the forks of a lift truck. As illustrated, FIG. 7d also provides a lid 155 made also from a panel construction according to the invention where the internal zone 156 within the peripheral frame 11 has an internal dimension approximating the external perimeter of the top edge of the container. The outer plastic film skin of the lid 155 may be reasonably flexible to allow the lid 155 to be pushed to the position illustrated and if necessary fastened by any suitable means in this position. The nature of the plastics material film of the lid 155 and the side walls of the container 132 to 135 may provide a seal between the lid and the side walls.

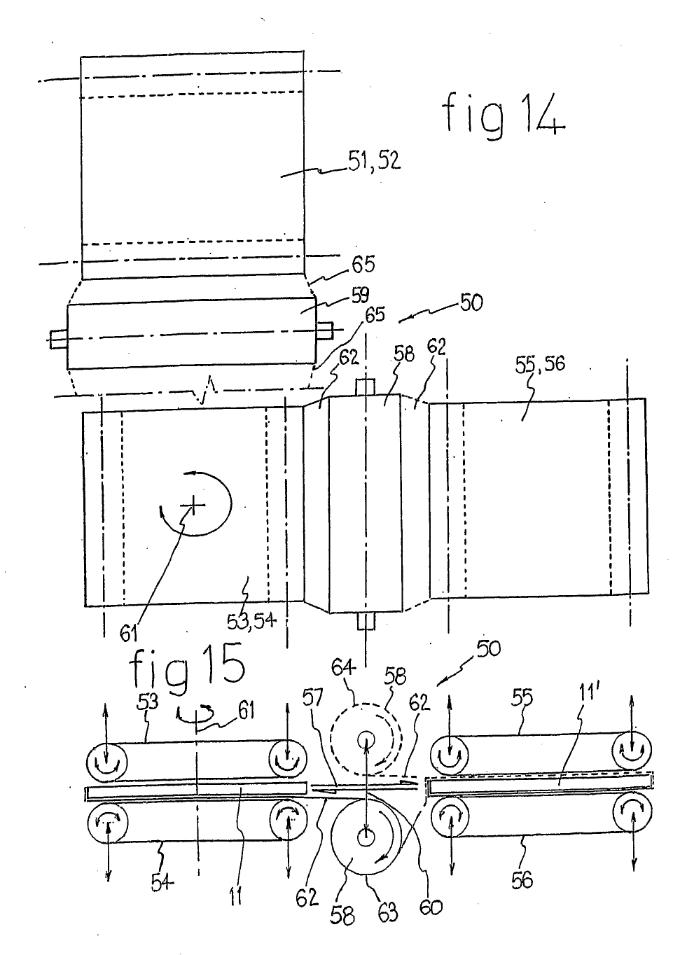

FIG. 12 illustrates schematically one form of panel construction 10 capable of being used as a raft on water storage zones such as ponds, dams, swimming pools and the like to reduce evaporation therefrom. In this case the frame structure 11 is formed from plastic piping, however, any other material may be used provided that the structure floats on the surface of the water storage. The panel construction 10 may simply have a substantially flat outer skin (plastics film layers) on its upper and lower surfaces. For larger panel constructions 10, the longer frame legs 160 and 161 may be braced by one or more cross brace member(s) 163 to prevent inward bowing of these legs. If desired, the or each cross brace member 163 may have a short upright member 164 extending upwardly from one (or both) sides such that the wound plastics film web layers (represented by lines 165) are inclined upwardly from the perimeter frame 11 to a free end 166 of the or each upright member 164. The inclines surfaces of the film layers thereby allow any rain falling on the panel construction 10 to readily drain back into the water storage area. The large water contact surface zone of the film layers is believed to create sufficient water tension to prevent the panel constructions/rafts from being blown over off or out of the water storage area under high wind conditions. While the frame forming members shown in FIG. 12 represent assembled plastic piping, these members may be made from solid or hollow materials including wood, metal and bamboo. The cross-sectional shape need not be circular and could also be square, rectangular or other shapes. The plastics material film applied to form the outer skin is applied with sufficient applied tension or retained tension (pre-stretched film) to ensure the outer skin is quite firm, watertight, and not easily flexed.

FIG. 13 illustrates in partial cross-section a variation on the panel construction rafts of FIG. 12 for desalinating sea or other salty water in a relatively simple and inexpensive manner. The apparatus 10 includes an internal perimeter frame 11, at least a part 170 of which is hollow. The frame 11 has a surrounding outer skin of plastics material film layers 12 generally as described with any other embodiment. The lower layers 17 of the skin 12 are generally black or darkly opaque film layers and the upper layers 172 are conveniently clear or highly translucent, the manufacture of which is explained elsewhere in this specification. The upper layers 172 are also inclined downwardly to the outer peripheral frame 11. The structure illustrated may be arranged to float on sea (or other similar) water zones 173 but can also be located on a land base. The structure is provided with an inlet arrangement 174 to allow the external water to enter zone 13 within the panel construction 10 and spread relatively thinly across the black or opaquely dark layers 171 forming the lower surface. An outlet arrangement for more highly concentrated salty water is provided (not shown) distant from the inlet arrangement 174. A control system to control flow of water containing salts into and out of the interior zone 13 is provided but not shown. In use the salty water within the zone 13 is heated by solar energy passing through the upper layers 172 and pure water is evaporated therefrom in the form of water vapour. This water vapour condenses on the inner surface 175 of the upper layers 172 and flows down this surface to be collected at collection zones 176 in the peripheral frame 11, the collection zones 176 having apertures 177 to enable the pure water to be collected in the hollow zone or zones of the part 170 of the perimeter frame 11. Once this pure water has built up to a sufficient degree, it may be pumped out of this zone (or zones) to a pure water collection tank or the like (not shown).

In another preferred application, a panel construction 10 as generally described in the foregoing can be used to provide a base structure for an advertising or similar signage display. In this case, again the outer skin tension should be maintained reasonably high and as needed, the internal frame formations may include appropriate cross or other bracing to maintain an outer perimeter that is substantially not bowed inwardly. Such signage displays may have the desired graphics display printed directly onto the outer skin of the panel construction and if necessary, the outer surface layers of the panel outer skin may be specifically selected to accept appropriate direct printing techniques. Alternatively, the panel construction 10 might be utilized simply as a sub support for conventional graphics on paper, plastics or similar sheeting that is then adhered in a conventional manner to one surface of the panel construction.

In further possible arrangements, the outer layer of the panel construction on which the signage/graphics is printed or adhered, can be made detachable from the remaining outer skin of the panel construction. This, when the life of the signage/graphics material is completed, the outer layer can simply and easily be stripped off the panel construction for re-use as desired. It may be possible for example to provide several different signs or graphics on various layers that are progressively stripped off after a period of time to reveal a new signage or display thereunder. Alternatively, where the signage/graphics material is separately adhered, it is possible to simply overlay the old graphics with new graphics.

The panel construction as aforesaid has a number of advantages over conventional signage in that they are significantly cheaper to produce and can be made weatherproof in an inexpensive manner thereby enabling the use of less expensive materials in their construction. The panel construction 10, in one preferred arrangement may be weatherproof and/or waterproof and can be used for external applications or internal applications where the panel construction or product made therefrom, might be subject to degradation by excessive moisture levels. A panel construction in accordance with this aspect where the internal cavity 13 is sealed, at least on one side, might be used in applications such as a raft or other floating uses such as a cover for swimming pools and other water holding facilities. A plurality of such panels could also be formed together to form such devices as rafts or floating covers for pools and the like.

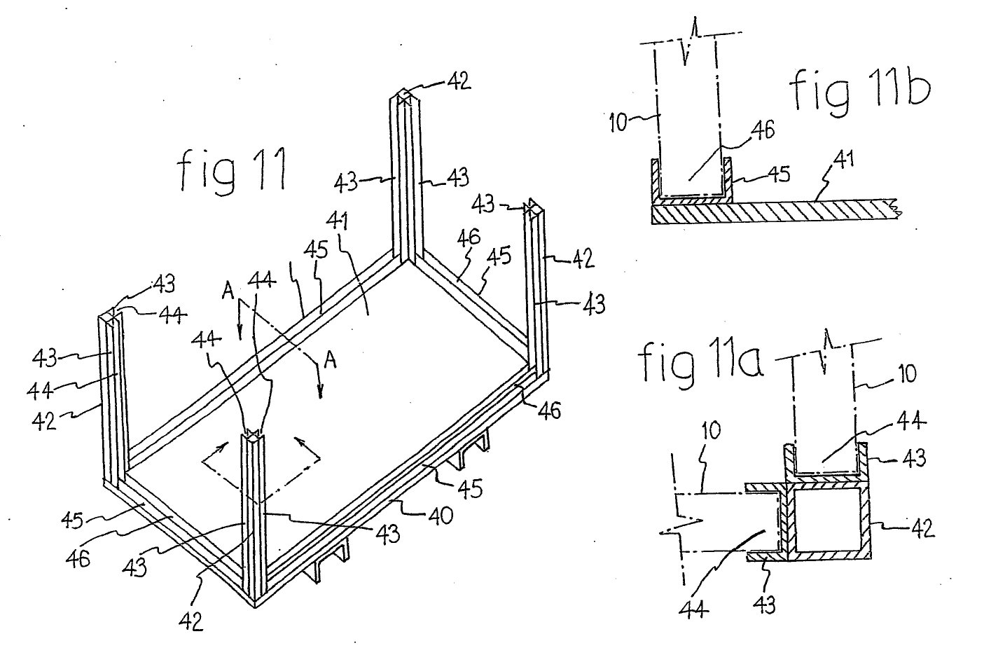

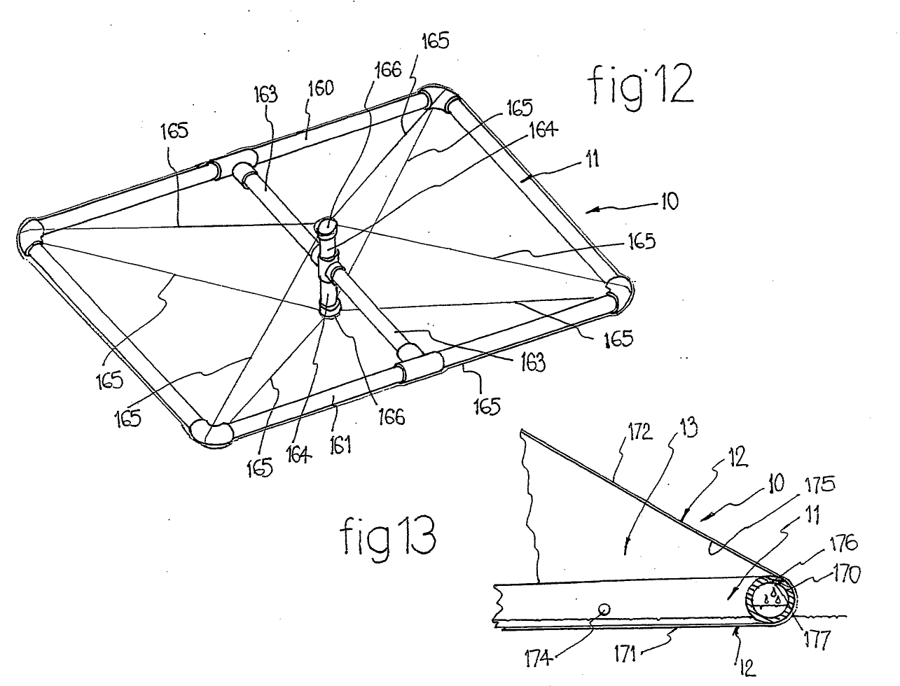

FIGS. 11, 11a and 11b illustrate another product in which a panel construction 10 might be used. In this further preferred embodiment, a container is formed on a pallet construction 40 of any suitable type having a supporting base wall 41. Corner posts 42 might be releasably positioned at the corners of the base supporting wall 41 with each of the corner posts 42 having channel members 43 secured thereto with the open channel 44 of the channel member 43 facing along a side or end edge of the supporting base wall 41. If desired, a base channel member 45 having its open channel 46 facing upwardly is positioned along each side or end edge of the base wall 41. The base channel members 45 may also be releasably connected to the pallet construction 40. As is shown in the drawing, a pallet construction 10 might be positioned and retained in the open channels 44 and 46 of the channel members 43 and 45. With larger panel constructions 10 as might be needed in this application, it may be desired to provide at least one internal strengthening rib or bar traversing the internal cavity 13 in at least one direction with opposed ends of same being connected to a portion of the rigid perimeter frame 11. Arrangements of this type might also be used in green house or similar structures.

In another preferred embodiment the internal frame structure might be formed by cardboard or corrugated cardboard or moulded plastic with crease lines being positioned to allow the panel construction to be folded about same in use. The internal frame structure might then be wrapped with a flexible plastics film web (or webs) in one (or two) directions about the edges of the internal cardboard or plastic frame with overlapping layers being at least partially adhered to one another. Such a construction might typically be used as supporting and protective packaging for individual bottles such as wine bottles or the like.

In a still further preferred embodiment, a container for retaining, carrying, transporting or storing liquids and flowable materials may be produced utilising a structure comprising an internal support frame defining an internal space or zone with the frame being wound with flexible plastics material film in a plurality of layers. In the case of the frame and therefore, the container, being cuboid in shape, the plastics material web may be wound about the frame in three directions disposed at 900 to each other to completely cover the six faces of the cuboid shape to form a sealed zone within the outer skin. An opening can then be formed in one face of the outer skin to provide an access means for filling and dispensing liquid or particulate material from the container. The opening may further include resealable closure means if desired.

FIGS. 14 and 15 illustrate schematically one possible form of apparatus for manufacturing objects or panel constructions 10 as described in the preceding text. It will of course be appreciated that many other forms of apparatus might be used including manual and semi-manual techniques. FIG. 14 shows a plan view of the apparatus with FIG. 15 showing a side elevation view of the apparatus. The illustrated apparatus 50 includes three pairs of conveyors 51/52, 53, 54 and 55/56, with the conveyors in each pair confronting one another with a work space in between adapted in use to receive a rigid perimeter frame 11 in between the conveyors. The conveyor pairs 53/54 and 55/56 are adapted to pass the frame 11 between the respective pairs as indicated by arrows 57 as described hereafter. Between the respective pairs of conveyors 53/54 and 55/56, a roll 58 of flexible plastics material film web is positioned to apply the film web to the frame 11 essentially as it moves by the conveyor pairs and between the conveyor pairs. The roll of film 58 is also movable vertically as indicated by arrow 60. Finally the pair of conveyors 53/54 may be bodily rotatable about the pivot axis 61 such that they might cooperate with the pair of conveyors 55/56 or with a separate pair of rollers 51/52 utilising another film roll 59 movably similarly to the roll of film 58.

Reference will now be made to FIG. 15 as annexed hereto. With the frame 11 initially in the left hand illustrated position with a film web 62 positioned along a lower face of the frame 11 and the roll 58 in the lower position 63, the roll 58 is moved vertically to its upper position 64 and the frame 11 is moved to its right ultimately to the position illustrated at 11′. In this position, the film web 62 has been positioned along the upper face of the frame 11. At this point the film roll 58 is moved again to its lower position 63 and the frame 11 is moved to the left hand position by the conveyor pairs 55/56 and 53/54. In so doing a second layer of film web is applied over the first laid layer along the lower face of the frame 11. The process is repeated to apply the desired number of layers of the film web 62 to the frame 11. When this has been completed, the film web 62 is severed and the conveyor pair 53/54 is rotated through 900 about axis 61 carrying with it the partially wrapped frame 11. The wrapping process is then repeated with the partially wrapped frame 11 being again passed between conveyor pairs 53/54 and 55/56 with the film web 62 from roll 58 being applied at an angle of substantially 90° to the first laid web. It will of course be appreciated that the same effect may be achieved without the conveyor pair 53/54 being bodily rotatable about the axis 61, by similarly removing the partially wrapped frame 11 and manually or semi-manually reorienting the frame 11 to the 90° position before repositioning same between the conveyor pairs 53/54. If it is desired to conveniently apply a differing film or other web material 65, a second pair of confronting conveyors 51/52 may be provided, 90° disposed relative to the conveyors 53/54, with a roll 59 of the required film or web material 65 disposed between the conveyor pairs 51/52 and 53/54. The roll 59 is disposed at 900 to the first roll 58 and is movable in a similar manner to the first roll 58. In a still further possible arrangement, four pairs of confronting conveyors might be provided with the first and second pairs being disposed at 900 to the third and fourth pairs of conveyors. The frame 11 in such an arrangement would be wrapped in a first direction by cooperation of the first two pairs of conveyors and an intervening roll of film, before being passed between the second and the third pairs of conveyors to thereafter be wrapped in a second direction by an intervening roll of film or web material between the third and fourth pairs of conveyors. In any of the above embodiments, the process of wrapping in separate directions might be repeated as many times as desired. Preferably each of the webs 62/65 has a width slightly greater than that of the frame 11 with press means (not shown) to press the extending edge portions against side edges of the frame 11. Conveniently the arrangement of each conveyor pair such as the illustrated pairs 51/52, 53/54 and 55/56 might be adjustable to accommodate differing thickness, width and length frames 11.

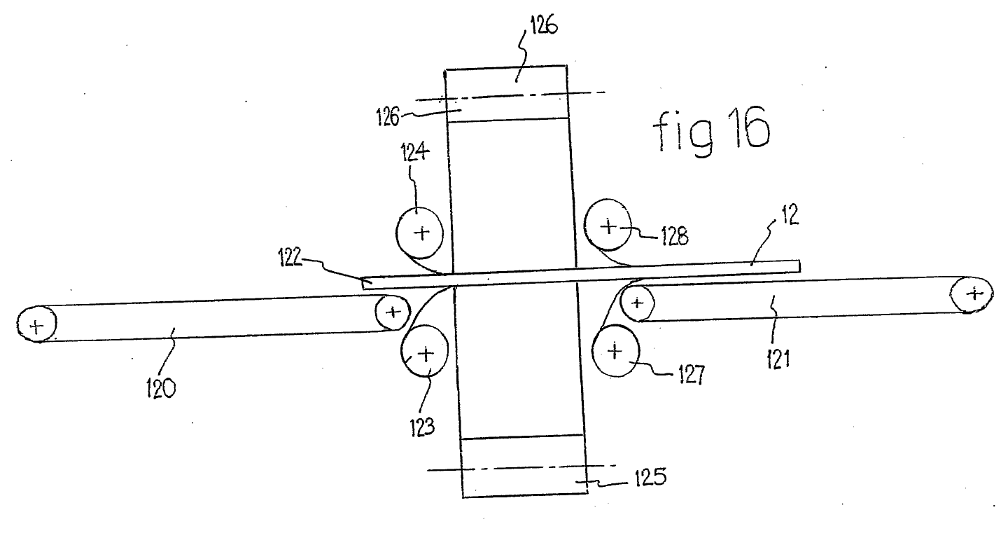

FIG. 16 illustrates another possible method of forming the outer skin 12 on any of the frame assemblies described in this specification. In this embodiment a pair of conveyors 120, 121 are provided to support a frame 122 while moving same to the left or to the right as illustrated in FIG. 16. A pair of film rolls 123, 124 are provided to lay a film web along the top and the bottom of the frame 122 while a second pair of film rolls 125, 126 orbit around the frame 122 between the conveyors 120, 121 to lay film in overlapping helical windings on the first laid film from the rolls 123, 124. Finally a second pair of film rolls 127, 128 is provided to apply film over the spirally wrapped film layers from rolls 125, 126 in the same general direction as the rolls 123, 124. It will of course be recognized that one of the rolls 125, 126 might be omitted or additional rolls could be added to apply the spirally wound layers. The process might also be repeated by running the partially wrapped frame 122 in a reverse direction (right to left) through the machine.

In a still further aspect, because the panel constructions 10 or container 25 formed therefrom has air trapped in the cavity 13 and/or between the film layers, such panel constructions and containers formed therefrom have excellent heat insulation properties. This would be an advantage and/or necessity when the containers are used for frozen or chilled produce, for example in manufacturing refrigerated containers, replacing Styrofoam for packaging fresh or frozen fish or produce or large produce bins used in a coolstore. The panel constructions could be used for temporary housing remaining cool in the summer and retaining heat in the winter. The same would apply for greenhouses because the panel constructions are insulated, heating and/or cooling costs would be greatly reduced. The panel constructions could also be used as insulation in buildings replacing other insulation methods. Because the volume of film is low per square metre the amount of flammable material is minimal although it may be preferable to at least treat the external layers of film with a fire retardant additive. If an adhesive is used, then a fire retardant adhesive would be preferred. In relation to a possible fire risk, there is substantially less material to burn when compared to Styrofoam or polyurethane.

If the panel constructions were to be used for more permanent building or other structures, they could be coated with plaster, render, plywood panelling, rigid plastic, steel or aluminium sheeting or some other appropriate finish for example in refrigerated containers, coolstores, insulated building structures etc. In the case of such containers or panels because the insulation is film and air and the film acts as a support, such panel constructions and containers have a much reduced weight when compared to other known constructions thus leading to much lower freight cost and building loadings.

In a further aspect, because the walls of the container or the panel construction are made with flexible film and are filled with air, products packed in such containers are in contact with flexible walls and base and are therefore better protected than in other containers or panels. Similarly, when the container does include a lid, the lid may be similarly constructed providing a similar improved level of protection for the container contents. Thus a container made in such a manner could be used as a protective package for whitegoods and other breakable and/or valuable products. This would also be important when packing and storing fruit and vegetables as there are minimal solid surfaces to bruise or damage such produce. Smaller containers could be used for packaging wine bottles or the like.

In a further important aspect, the main cost in the production of such panel constructions or containers is the framing material and fabrication of the frame. It is therefore highly desirable that after use or damage the panels or containers are either re-wrapped over the existing film or the film is stripped off and the frames are simply wrapped again to produce another panel or container using the same framing material. Thus containers or panel constructions made as described above are reusable and recyclable for many years.

In another aspect, panel constructions utilising waterproof materials for the frame 11 makes it possible to store and run liquids in such frames or the panel constructions. Such panel constructions can be used for storing, heating, solarisation and purification of water. They can also float on dams, canals etc. to reduce evaporation.

In a still further aspect, the frame 11 may be wrapped with a plastic film that will shrink when subjected to an elevated temperature whereby such panel constructions may be passed through an oven or over or past heating means to shrink the film onto the frame 11. The resultant panel or other object will have an improved taut and smooth outer surface.

1. A panel or object construction including an inner support frame means and an outer skin at least partially enclosing said support frame means formed at least in part by at least one layer, of at least one flexible web wound about said support frame means with pressure applied by said flexible web to said support frame means at least partially overlapping a previously positioned said flexible web whereby at least some overlapping regions of a said web or webs are adhered to each other.

2. A panel or object construction according to claim 1 wherein a plurality of said layers are provided whereby at least some of said layers are adhered to at least one other said layer.

3. (canceled)

4. A panel or object construction according to claim 1 wherein said support frame means is a single frame element.

5. A panel or object construction according to claim 1 wherein said support frame means includes at least two frame elements, the or each said frame element being spaced apart and wound by said flexible web or webs such that the flexible web or webs between adjacent frame elements forms a hinge means.

6. A panel or object construction according to claim 4 wherein said single frame element includes at least two parts interconnected by hinge means.

7. A panel or object construction according to claim 1 wherein the inner support frame means is fully enclosed by said outer skin.

8. A panel or object construction according to claim 7, wherein the flexible web or webs are wound in at least two directions disposed at different angles relative to each other, preferably at substantially 90°.

9. A panel or object construction according to claim 1 wherein the or each said flexible web is a flexible plastics film web.

10. A panel or object construction according to claim 9 wherein the or each said flexible plastics film web is a pre-stretched plastics film beyond its yield point to increase its length and decrease its thickness, the film retaining some memory.

11. (canceled)

12. A panel or object construction according to claim 9 wherein air is trapped and retained within said outer skin.

13.-14. (canceled)

15. A panel or object construction according to claim 9 wherein the flexible plastics film web or webs include self adherent characteristics, or a separate adhesive or adhesive layer is used to adhere the layers of the flexible web or webs together.

16. A panel or object construction according to claim 1 wherein the support frame means includes a perimeter substantially rigid frame formation defining a substantially open space inwardly of said perimeter rigid frame formation.

17.-26. (canceled)

27. An evaporation restrictor for restricting evaporation from a body of water including a panel according to claim 9, wherein the outer skin is formed at least in part by at least one layer of at least one flexible plastics film web wound about said support frame means with pressure applied by said flexible web to said support frame means at least partially overlapping a previously positioned said flexible plastics film web whereby at least some overlapping regions of a said flexible plastics film web or webs are adhered to each other.

28. A desalination apparatus comprising a panel according to claim 9, wherein the inner support frame means is substantially rigid and said outer skin enclosing said inner support frame means is formed at least in part by at least one layer of at least one flexible plastics film web wound about said support frame means at least partially overlapping a previously positioned said flexible plastics film web whereby at least some overlapping regions of a said flexible plastics film web or webs are adhered to each other, said support frame means and said outer skin defining a sealed internal zone having inlet and outlet arrangement means to introduce and remove water to be desalinated to and from said internal zone, said outer skin having at least one upper region upwardly inclined from at least one hollow zone of said support frame means, said support frame means further including water collection and drainage means to collect pure water condensed on said upwardly inclined region and deliver same to said at least one hollow zone of the support frame means.

29. A container constructed from at least one panel construction according to claim 1.

30. A container according to claim 29 wherein a plurality of said panel constructions are provided connected together via hinge means such that the container can be transported in a substantially flat condition and erected into said container by an end user.

31.-33. (canceled)

34. A wall construction element including at least one rectangular shaped panel construction according to claim 1, further including retainer means engaging and retaining at least one of opposed edges of said panel construction.

35.-37. (canceled)

38. A panel construction according to claim 1, wherein the inner support frame means has two mutually parallel first frame members spaced from one another with each said first frame member having at least one hinge zone such that the hinge zones in the spaced first frame members are arranged in at least one pair with the or each said pair defining a hinging axis about which portions of the first frame members on either side of said hinge zones can be positioned into differing relative dispositions, after having said flexible outer skin applied to said inner support frame means.

39.-53. (canceled)

54. A flat panel assembly including a plurality of panel constructions according to claim 16 arranged adjacent each other substantially in a plane and an outer envelope formed by at least one layer of a flexible plastics film web material wound about all of said frame formations to at least partially overlap a previously laid length of the flexible plastics film web material with at least some overlapping regions of said web material being adhered to one another.

60. A flat panel assembly including a plurality of panel constructions according to claim 1 arranged adjacent each other substantially in a plane, and at least one continuous layer adhered to one side only of said panel constructions.

61.-63. (canceled)

64. Apparatus for wrapping a support frame means with an outer skin formed at least in part by a plurality of layers of a flexible web wound about said support frame means, said apparatus including a first conveying means and a second conveying means, the first and the second conveying means being arranged to move the support frame means to and fro between the first and second conveying means, and a roll of said flexible web disposed between the first and the second conveying means being movable between a relatively elevated position and a relatively lowered position, the flexible web being successively positioned along a first face of the support frame means with the roll of said flexible web in the elevated position as the support frame means moves between the first and the second conveying means, whereupon, the roll of said flexible web moves to the lowered position and the flexible web is positioned along a second face of the support frame means opposite to said first face as the support frame means moves again between the first and the second conveying means.

65.-68. (canceled)

69. Apparatus for wrapping a support frame means with an outer skin formed at least in part by a plurality of layers of a flexible web wound about said support frame means, said apparatus including a first conveying means and a second conveying means being arranged to move the support frame means between the first and the second conveying means, and at least one roll of flexible web disposed generally between said first and said second conveying means and disposed to orbit about said support frame means as it moves between the first and the second conveying means to lay helical windings of said flexible web onto said support means, said apparatus further including first flexible web application means to apply at least one flexible web length either below or over the helical windings in a longitudinal direction of said support frame means on opposed faces of said support frame means.

70. (canceled)

71. A panel or object construction according to claim 16 wherein an inlet means is provided enabling a liquid to be delivered to said substantially open space.

72. A panel or object construction according to claim 16 further including outlet means enabling a liquid to be removed from within said outer skin.

73. A panel or object construction according to claim 16 wherein a region of said outer skin forms an inclined surface leading upwardly and inwardly from a section of said perimeter rigid frame.

74. A panel or object construction according to claim 73 including multiple said inclined surfaces each leading upwardly and inwardly from a separate said section of said perimeter rigid frame.

75. A panel or object construction according to claim 73 wherein the outer skin forming a base region of said panel or object construction spanning a zone within said perimeter rigid frame is coloured black or is darkly opaque.

76. A panel or object construction according to claim 73 wherein the outer skin forming the or each said inclined surface is clear or highly translucent.
